(19) United States
(12) Patent Application Publication
(10) Pub. No.: US 2019/0118311 A1
(43) Pub. Date: Apr. 25, 2019

(54) ALUMINUM ALLOY BRAZING SHEET

(71) Applicants: KABUSHIKI KAISHA KOBE SEIKO SHO (KOBE STEEL, LTD.), Kobe-shi (JP); DENSO CORPORATION, Kariya-shi (JP)

(72) Inventors: Shimpei KIMURA, Moka-shi (JP); Yuji SHIBUYA, Moka-shi (JP); Akihiro TSURUNO, Moka-shi (JP); Hayaki TERAMOTO, Kariya-shi (JP); Tetsuya YAMAMOTO, Kariya-shi (JP); Kota HAGIHARA, Kariya-shi (JP); Yosuke UCHIDA, Kariya-shi (JP)

(73) Assignees: KABUSHIKI KAISHA KOBE SEIKO SHO (KOBE STEEL, LTD.), Kobe-shi (JP); DENSO CORPORATION, Kariya-shi (JP)

(21) Appl. No.: 16/089,653

(22) PCT Filed: Mar. 9, 2017
(86) PCT No.: PCT/JP2017/009510

§ 371 Date: Sep. 28, 2018

(30) Foreign Application Priority Data
Mar. 31, 2016 (JP) 2016-072159

(51) Int. Cl. B23K 35/28; B23K 35/02; B32B 15/01; C22C 21/02; C22C 21/10; C22C 21/08; C22C 21/16; C22C 21/14

(52) U.S. Cl. CPC B23K 35/286; B23K 35/0238; B32B 15/016; C22C 21/02; F28F 21/084; C22C 21/08; C22C 21/16; C22C 21/14; C22C 21/10

(57) ABSTRACT

An aluminum alloy brazing sheet 1 characterized by comprising a core material 2, a brazing material 3 made of an Al—Si based alloy provided on one surface of the core material 2, a sacrificial material 4 provided on another surface of the core material 2, and an intermediate material 5 provided between the core material 2 and the sacrificial material 4; a plate thickness being less than 200 μm; the core material 2 containing a predetermined amount of Mn and Cu, with a balance being Al and inevitable impurities; the sacrificial material 4 containing a predetermined amount of Zn and less than a predetermined amount of Mg, with a balance being Al and inevitable impurities; and the intermediate material 5 containing a predetermined amount of Mg with a balance being Al and inevitable impurities.

### TECHNICAL FIELD

The present disclosure relates to an aluminum alloy brazing sheet used for a heat exchanger for automobile, and the like.

### BACKGROUND ART

In recent years, a heat exchanger for automobile tends to be lighter and more compact, and accordingly it is desired to reduce the thickness of a brazing sheet constituting a tube material that accounts for most of the mass of heat exchanger. In order to reduce the thickness, it is necessary to achieve higher strength and higher corrosion resistance corresponding to the extent of thinning.

For example, Patent Literature 1 discloses a brazing sheet (aluminum alloy composite material) having high strength, high corrosion resistance, and excellent brazing property. This brazing sheet adds a predetermined amount of Mg to a sacrificial material (linear material) of a clad material, so that element diffusion at the time of brazing heating is utilized, allowing Mg added to the sacrificial material and Si in a brazing material to diffuse in a core material. As a result, an Mg—Si intermetallic compound is generated within the core material, enhancing the strength after brazing of the clad material. In addition, Mg added to the sacrificial material does not reach the brazing material layer, so that deterioration of the brazing property is avoided. Furthermore, in case of a radiator tube and the like, this sacrificial material remarkably improves the corrosion resistance.

Patent Literature 2 discloses a brazing sheet excellent in brazing property and strength after brazing using an Al—Si—Fe—Cu—Mn—Mg based alloy in which Mg is added to a core material of the brazing sheet.

### CITATION LIST

### Patent Literature

Patent Literature 1: JP-B-2564190

Patent Literature 2: JP-A-2009-22981

### SUMMARY OF THE INVENTION

### Technical Problems

However, such related arts have the following problems.

The brazing sheet disclosed in Patent Literature 1, in which Mg is added to the sacrificial material, is used for an electric resistance welded tube or the like that does not require the brazing property on the side of the sacrificial material. However, the brazing sheet disclosed in Patent Literature 1 is difficult to apply to a tube having such a shape that the side of the sacrificial material is brazed.

In addition, in the brazing sheet disclosed in Patent Literature 2, if Mg is further added to the core material for further strengthening, the brazing property on the side of the brazing material is lowered.

Moreover, for the brazing sheet, in order to further reduce the thickness, it is further desired to improve the strength and corrosion resistance while maintaining brazing property.

An embodiment of the present invention is to solve the above problems, and has an object to provide an aluminum alloy brazing sheet which is excellent in strength after brazing, as well as excellent in brazing property on both sides of a brazing material and a sacrificial material, and corrosion resistance on both sides of the brazing material and the sacrificial material, even when the sheet is a thin material having a plate thickness of less than 200 μm.

### Solution to Problems

An embodiment of the present invention is an aluminum alloy brazing sheet developed so as to be used as a brazing tube material for thin wall radiator and the like having a plate thickness of less than 200 μm, the sheet having high strength after brazing and high corrosion resistance while maintaining brazing property.

The inventors have made intensive studies to solve the above-mentioned problems by overcoming the difficulty of producing an aluminum alloy brazing sheet (hereinafter referred to as “brazing sheet” as appropriate) having a plate thickness of less than 200 μm sufficient for achievement of higher strengthening, higher brazing property, and higher corrosion resistance. As a result, it has been found that, in addition to both enhancement in brazing property on the side of a sacrificial material and strengthening of a core material by providing an intermediate material between the core material and the sacrificial material, regulating the content of Mg in the sacrificial material to less than a certain level, and adjusting the content of Mg in the intermediate material to a certain level, the corrosion resistance on the side of a brazing material can be ensured by imparting no Zn to the intermediate layer, or regulating the content of Zn in the intermediate layer to less than a certain level. Specifically, first, the sacrificial material plays a role of a Mg diffusion-suppressing layer for the intermediate material, so that the brazing property on the side of the sacrificial material is ensured. In addition, diffusion of Mg in the intermediate material towards the core material improves the strength after brazing of the core material, while the core material plays a role of a Mg diffusion-suppressing layer, so that the brazing property on the side of the brazing material is ensured. In addition, diffusion of Zn to the side of the brazing material is suppressed by the intermediate material in which no Zn is imparted or the content of Zn is regulated, so that the corrosion resistance on the side of the brazing material is improved.

Note that the diffusion of Mg, Zn is mainly due to heat treatment for brazing.

Furthermore, the inventors have found that the strength after heat treatment for brazing can be further improved by relatively increasing the added amount of Cu in the core material.

That is, an aluminum alloy brazing sheet according to an embodiment of the present invention is characterized by including a core material, a brazing material made of an Al—Si based alloy provided on one surface of the core material, a sacrificial material provided on another surface of the core material, and an intermediate material provided between the core material and the sacrificial material, a plate thickness being less than 200 μm, the core material containing Mn: 0.50% by mass or more and 2.0% by mass or less, and Cu: more than 1.20% by mass and 2.70% by mass or less, with a balance being Al and inevitable impurities, the sacrificial material containing Zn: 2.0% by mass or more and 12.0% by mass or less, and Mg: less than 0.05% by mass (including 0% by mass), with a balance being Al and inevitable impurities, the intermediate material containing Mg: 0.05% by mass or more and 3.0% by mass or less, with a balance being Al and inevitable impurities.

Such a constitution of the aluminum alloy brazing sheet according to an embodiment of the present invention can satisfy the strength after brazing, corrosion resistance and brazing property in a well-balanced manner and at higher levels.

In addition, the core material of the aluminum alloy brazing sheet according to an embodiment of the present invention preferably further contains Si: 0.05% by mass or more and 0.50% by mass or less.

Such a constitution can further improve the strength after brazing.

In addition, the core material of the aluminum alloy brazing sheet according to an embodiment of the present invention preferably further contains Mg: 0.05% by mass or more and 0.50% by mass or less.

Such a constitution can further improve the strength after brazing.

In addition, the core material of the aluminum alloy brazing sheet according to an embodiment of the present invention preferably further contains at least one selected from the group consisting of Cr: 0.01% by mass or more and 0.30% by mass or less, Zr: 0.01% by mass or more and 0.30% by mass or less, and Ti: 0.05% by mass or more and 0.30% by mass or less.

Such a constitution can further improve the strength after brazing and corrosion resistance.

In addition, the sacrificial material of the aluminum alloy brazing sheet according to an embodiment of the present invention preferably further contains Si: 0.20% by mass or more and 1.0% by mass or less.

Such a constitution can cause Si to form together with Al and Mn an intermetallic compound, and further improve the strength after brazing.

In addition, the sacrificial material of the aluminum alloy brazing sheet according to an embodiment of the present invention preferably further contains Mn: 0.10% by mass or more and 2.0% by mass or less.

Such a constitution can cause Mn to form together with Al and Si an intermetallic compound, and further improve the strength after brazing.

In addition, the sacrificial material of the aluminum alloy brazing sheet according to an embodiment of the present invention preferably further contains at least one selected from the group consisting of Ti: 0.01% by mass or more and 0.30% by mass or less, Cr: 0.01% by mass or more and 0.30% by mass or less, and Zr: 0.01% by mass or more and 0.30% by mass or less.

Such a constitution can further improve the corrosion resistance and strength after brazing.

In addition, the intermediate material of the aluminum alloy brazing sheet according to an embodiment of the present invention preferably further contains Si: 0.20% by mass or more and 1.0% by mass or less.

Such a constitution can cause Si to form together with Mg a precipitated phase, and further improve the strength after brazing.

In addition, the intermediate material of the aluminum alloy brazing sheet according to an embodiment of the present invention preferably further contains Mn: 0.10% by mass or more and 2.0% by mass or less.

Such a constitution can form a solid solution, and further improve the strength after brazing.

In addition, the intermediate material of the aluminum alloy brazing sheet according to an embodiment of the present invention preferably further contains Zn: less than 1.0% by mass.

Such a constitution can further not only improve the corrosion resistance on the side of the sacrificial material, but also ensure the corrosion resistance on the side of the brazing material.

In addition, the intermediate material of the aluminum alloy brazing sheet according to an embodiment of the present invention preferably further contains at least one selected from the group consisting of Ti: 0.01% by mass or more and 0.30% by mass or less, Cr: 0.01% by mass or more and 0.30% by mass or less, and Zr: 0.01% by mass or more and 0.30% by mass or less.

Such a constitution can further improve the corrosion resistance and strength after brazing.

### Advantageous Effects of Invention

The aluminum alloy brazing sheet according to an embodiment of the present invention is excellent in strength after brazing, as well as excellent in brazing property on both sides of the brazing material and the sacrificial material, and corrosion resistance on both sides of the brazing material and the sacrificial material, even when the sheet is a thin material having a plate thickness of less than 200 μm.

### BRIEF DESCRIPTION OF THE DRAWINGS

FIG. 1 is a cross-sectional view showing a configuration of an aluminum alloy brazing sheet according to an embodiment of the present invention.

FIG. 2 is a cross-sectional view of a test piece for evaluation for evaluating the brazing property between the sides of brazing materials of an aluminum alloy brazing sheet according to an embodiment of the present invention.

FIG. 3 is a cross-sectional view of a test piece for evaluation for evaluating the brazing property between the side of a brazing material and the side of a sacrificial material of an aluminum alloy brazing sheet according to an embodiment of the present invention.

### DESCRIPTION OF EMBODIMENTS

Hereinafter, a detailed description will be made of a mode for carrying out an aluminum alloy brazing sheet of the present invention.

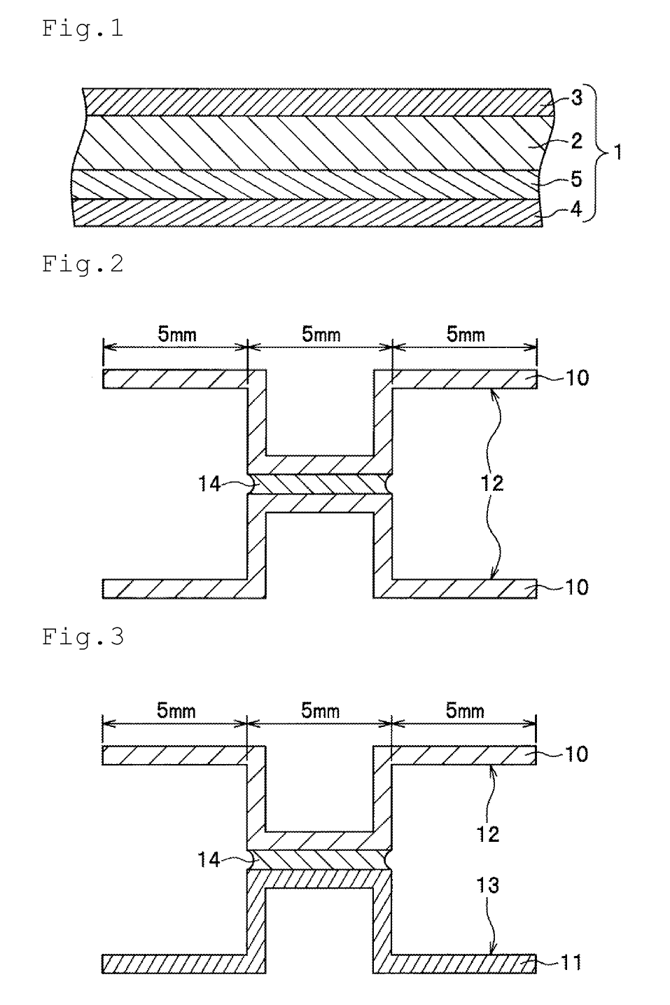

As shown in FIG. 1, the aluminum alloy brazing sheet 1 includes a core material 2, a brazing material 3 made of an Al—Si based alloy provided on one surface of the core material 2, a sacrificial material 4 provided on the other surface of the core material 2, and an intermediate material 5 provided between the core material 2 and the sacrificial material 4, the plate thickness being less than 200 μm.

Descriptions will be sequentially made below of the core material 2, brazing material 3, sacrificial material 4, and intermediate material 5 constituting the aluminum alloy brazing sheet 1 according to an embodiment of the present invention.

### <Core Material>

The core material 2 according to an embodiment of the present invention contains a predetermined amount of Mn and Cu, with a balance being Al and inevitable impurities.

In addition, the core material 2 according to an embodiment of the present invention preferably further contains a predetermined amount of Si. In addition, the core material 2 according to an embodiment of the present invention preferably further contains a predetermined amount of Mg. Furthermore, the core material 2 according to an embodiment of the present invention preferably further contains a predetermined amount of at least one selected from the group consisting of Cr, Zr, and Ti.

A description will be made below of each of elements constituting the core material 2 according to an embodiment of the present invention. Note that the content of each component is the content in the whole core material 2.

### (Mn in Core Material: 0.50% by Mass or More and 2.0% by Mass or Less)

Mn forms together with Al and Si an intermetallic compound, which finely distributes in a crystal grain to contribute to the dispersion strengthening, and improve the strength after brazing. When the content of Mn is less than 0.50% by mass, the number of intermetallic compounds decreases, so that the dispersion strengthening by the intermetallic compound is not improved and the strength after brazing is lowered. On the other hand, when the content of Mn exceeds 2.0% by mass, a large number of coarse intermetallic compounds are produced, which make rolling difficult, and make manufacturing of the brazing sheet 1 difficult. Therefore, the content of Mn in the core material 2 is adjusted to 0.50% by mass or more and 2.0% by mass or less. The content of Mn is preferably 0.70% by mass or more, more preferably 0.90% by mass or more, from the viewpoint of further improving the above effect. In addition, the content is preferably 1.8% by mass or less, more preferably 1.7% by mass or less, from the viewpoint of further suppressing formation of coarse intermetallic compounds.

(Cu in Core Material: More than 1.20% by Mass and 2.70% by Mass or Less)

Cu contributes to improvement of the strength after brazing by solid solution strengthening. When the content of Cu is 1.20% by mass or less, in case of the brazing sheet 1 having a plate thickness of less than 200 m, the amount of Cu remaining after brazing is so insufficient that the strength after brazing becomes insufficient. On the other hand, when the content of Cu exceeds 2.70% by mass, the solidus temperature of the core material 2 is lowered, so that melting may occur at the time of brazing. Therefore, the content of Cu in the core material 2 is adjusted to more than 1.20% by mass and 2.70% by mass or less. The content of Cu is preferably 1.3% by mass or more, more preferably 1.4% by mass or more, from the viewpoint of further improving the above effect. In addition, the content is preferably 2.6% by mass or less, more preferably 2.5% by mass or less, from the viewpoint of further suppressing lowering of the solidus temperature of the core material 2.

### (Si in Core Material: 0.05% by Mass or More and 0.50% by Mass or Less)

Si forms together with Al and Mn an intermetallic compound, which finely distributes in a crystal grain to contribute to the dispersion strengthening, and improve the strength after brazing. When the content of Si is less than 0.05% by mass, the effect of improving the strength after brazing becomes insufficient. On the other hand, when the content of Si exceeds 0.50% by mass, the solidus temperature of the core material 2 is lowered, so that the core material 2 may melt at the time of brazing heating. Therefore, when Si is contained in the core material 2, in order to obtain the Si-contained effect, the content of Si is adjusted to 0.05% by mass or more and 0.50% by mass or less. The content of Si is preferably 0.10% by mass or more, more preferably 0.15% by mass or more, from the viewpoint of further improving the above effect. In addition, the content is preferably 0.45% by mass or less, more preferably 0.40% by mass or less, from the viewpoint of further suppressing lowering of the solidus temperature of the core material 2. Note that the content of Si may be 0% by mass.

### (Mg in Core Material: 0.05% by Mass or More and 0.50% by Mass or Less)

Mg forms together with Si a fine precipitated phase of Mg₂Si, providing an effect of improving the strength after brazing. When the content of Mg is less than 0.05% by mass, the effect of improving the strength after brazing becomes insufficient. On the other hand, when the content of Mg exceeds 0.50% by mass, in case where brazing using a non-corrosive flux is performed, the flux and Mg react with each other, so that brazing may be impossible. Therefore, when Mg is contained in the core material 2, in order to obtain the Mg-contained effect, the content of Mg is adjusted to 0.05% by mass or more and 0.50% by mass or less. The content of Mg is preferably 0.07% by mass or more, more preferably 0.10% by mass or more, from the viewpoint of further improving the above effect. In addition, the content is preferably 0.45% by mass or less, more preferably 0.40% by mass or less, from the viewpoint of further improving the brazing property. Note that the content of Mg may be 0% by mass.

### (Cr in Core Material: 0.01% by Mass or More and 0.30% by Mass or Less)

Cr forms together with Al an Al₃Cr intermetallic compound, providing an effect of improving the strength after brazing. When the content of Cr is less than 0.01% by mass, the effect of improving the strength after brazing is insufficient. On the other hand, when the content of Cr exceeds 0.30% by mass, coarse intermetallic compounds are formed during casting, so that cracking may occur during rolling. Therefore, when Cr is contained in the core material 2, in order to obtain the Cr-contained effect, the content of Cr is adjusted to 0.01% by mass or more and 0.30% by mass or less. The content of Cr is preferably 0.05% by mass or more, more preferably 0.07% by mass or more, from the viewpoint of further improving the above effect. In addition, the content is preferably 0.25% by mass or less, more preferably 0.20% by mass or less, from the viewpoint of further suppressing formation of coarse intermetallic compounds. Note that the content of Cr may be 0% by mass.

### (Zr in Core Material: 0.01% by Mass or More and 0.30% by Mass or Less)

Zr forms together with Al an Al₃Zr intermetallic compound, providing dispersion strengthening, thereby providing an effect of improving the strength after brazing. When the content of Zr is less than 0.01% by mass, the effect of improving the strength after brazing is not sufficient. On the other hand, when the content of Zr exceeds 0.30% by mass, coarse Al₃Zr intermetallic compounds are formed during casting, so that cracking tends to occur during rolling. Therefore, when Zr is contained in the core material 2, in order to obtain the Zr contained effect, the content of Zr is adjusted to 0.01% by mass or more and 0.30% by mass or less. The content of Zr is preferably 0.03% by mass or more, more preferably 0.05% by mass or more, from the viewpoint of further improving the above effect. In addition, the content is preferably 0.25% by mass or less, more preferably 0.20% by mass or less, from the viewpoint of further suppressing formation of coarse Al₃Zr intermetallic compounds. Note that the content of Zr may be 0% by mass.

### (Ti in Core Material: 0.05% by Mass or More and 0.30% by Mass or Less)

Ti can distribute in an Al alloy in a layered manner, thereby reducing the progressing rate of corrosion in a plate thickness direction, so that it contributes to improvement of the corrosion resistance. When the content of Ti is less than 0.05% by mass, the layered distribution of Ti is so insufficient that the effect of improving the corrosion resistance is insufficiently obtained. On the other hand, when the content of Ti exceeds 0.30% by mass, coarse Al₃Ti intermetallic compounds tend to be formed during casting and workability is lowered, so that cracking tends to occur during rolling. Therefore, when Ti is contained in the core material 2, in order to obtain the Ti-contained effect, the content of Ti is adjusted to 0.05% by mass or more and 0.30% by mass or less. The content of Ti is preferably 0.07% by mass or more, more preferably 0.10% by mass or more, from the viewpoint of further improving the above effect. In addition, the content is preferably 0.25% by mass or less, more preferably 0.20% by mass or less, from the viewpoint of further suppressing formation of coarse Al₃Ti intermetallic compounds. Note that the content of Ti may be 0% by mass.

### (Balance in Core Material: Al and Inevitable Impurities)

In addition to the above components, the balance in the core material 2 is Al and inevitable impurities. Examples of the inevitable impurities include Fe, Zn, In, Sn, and Ni. As long as the contents are such that Fe is at 0.30% by mass or less (preferably 0.25% by mass or less), Zn is at 0.15% by mass or less (preferably 0.10% by mass or less), and each of In, Sn, and Ni is at 0.05% by mass or less (preferably 0.03% by mass or less), they do not prevent the effect of an embodiment of the present invention. Accordingly, they are allowed to be contained in the core material 2. Regarding the above-mentioned Si, Mg, Zr, Ti, and Cr, they can be regarded as inevitable impurities when each of them is contained below the lower limit.

Regarding Fe, Zn, In, Sn, Ni, and the like, as long as each of them does not exceed the above-mentioned predetermined content, not only when they are contained as inevitable impurities but also when they are positively added, they do not prevent the effect of an embodiment of the present invention.

The thickness of the core material 2 is not particularly limited, but from the viewpoint of improving the strength, the cladding rate is preferably 50% or more.

### <Brazing Material>

The brazing material 3 according to an embodiment of the present invention is composed of an Al—Si based alloy. Examples of the Al—Si based alloy include a general JIS alloy such as 4343 or 4045. Here, the Al—Si based alloy includes not only an Al alloy containing Si but also an Al alloy containing Zn. That is, the Al—Si based alloy includes an Al—Si based alloy or an Al—Si—Zn based alloy. Then, for example, the Al—Si based alloy containing Si: 5% by mass or more and 13% by mass or less can be used.

The thickness of the brazing material 3 is not particularly limited, but is preferably 15 μm or more, preferably 50 μm or less, from the viewpoint of making the amount of brazing material at a brazed joint more appropriate.

### <Sacrificial Material>

The sacrificial material 4 according to an embodiment of the present invention contains a predetermined amount of Zn and less than a predetermined amount of Mg, with a balance being Al and inevitable impurities.

In addition, the sacrificial material 4 according to an embodiment of the present invention preferably further contains a predetermined amount of Si. In addition, the sacrificial material 4 according to an embodiment of the present invention preferably further contains a predetermined amount of Mn. Furthermore, the sacrificial material 4 according to an embodiment of the present invention preferably further contains a predetermined amount of at least one selected from the group consisting of Ti, Cr, and Zr.

A description will be made below of each of elements constituting the sacrificial material 4 according to an embodiment of the present invention. Note that the content of each component is the content in the whole sacrificial material 4.

### (Zn in Sacrificial Material: 2.0% by Mass or More and 12.0% by Mass or Less)

Zn contributes to improvement of the corrosion resistance by making the potential of the sacrificial material 4 baser to cause a potential difference with respect to the core material 2. When the content of Zn is less than 2.0% by mass, the potential difference with respect to the core material 2 becomes so insufficient that the corrosion resistance becomes difficult to ensure. On the other hand, when the content of Zn exceeds 12.0% by mass, the sacrificial material 4 is so early exhausted that the corrosion resistance is lowered. Therefore, the content of Zn in the sacrificial material 4 is adjusted to 2.0% by mass or more and 12.0% by mass or less. The content of Zn is preferably 2.5% by mass or more, more preferably 3.0% by mass or more, from the viewpoint of further improving the above effect. In addition, the content is preferably 11.0% by mass or less, more preferably 10.0% by mass or less, from the viewpoint of further suppressing lowering of the corrosion resistance.

(Mg in Sacrificial Material: Less than 0.05% by Mass (Including 0% by Mass))

When the content of Mg in the sacrificial material 4 is 0.05% by mass or more, the brazing property on the side of the sacrificial material 4 is greatly lowered. Accordingly, in order to ensure the brazing property on the side of the sacrificial material 4, the content of Mg in the sacrificial material 4 is regulated to less than 0.05% by mass. The content of Mg is preferably 0.04% by mass or less, more preferably 0.03% by mass or less, from the viewpoint of further suppressing lowering of the brazing property on the side of the sacrificial material 4. The lower limit is preferably 0% by mass, but since it is difficult to adjust the content to 0% by mass, the lower limit may be adjusted to 0.005% by mass. However, if it is possible to adjust the content to 0% by mass, it is preferably 0% by mass.

### (Si in Sacrificial Material: 0.20% by Mass or More and 1.0% by Mass or Less)

Si forms together with Al and Mn an intermetallic compound, which finely distributes in a crystal grain to contribute to the dispersion strengthening, and improve the strength after brazing. When the content of Si is less than 0.20% by mass, the effect of improving the strength after brazing becomes insufficient. On the other hand, when the content of Si exceeds 1.0% by mass, the solidus temperature is lowered, so that the sacrificial material 4 may melt at the time of brazing. Therefore, when Si is contained in the sacrificial material 4, in order to obtain the Si-contained effect, the content of Si is adjusted to 0.20% by mass or more and 1.0% by mass or less. The content of Si is preferably 0.25% by mass or more, more preferably 0.30% by mass or more, from the viewpoint of further improving the above effect. In addition, the content is preferably 0.90% by mass or less, more preferably 0.80% by mass or less, from the viewpoint of further suppressing lowering of the solidus temperature. Note that the content of Si may be 0% by mass.

### (Mn in Sacrificial Material: 0.10% by Mass or More and 2.0% by Mass or Less)

Mn forms together with Al and Si an intermetallic compound, which finely distributes in a crystal grain to contribute to the dispersion strengthening, and improve the strength after brazing. When the content of Mn is less than 0.10% by mass, the effect of improving the strength after brazing is insufficient. On the other hand, when the content of Mn exceeds 2.0% by mass, coarse intermetallic compounds are formed during casting and workability is lowered, so that cracking tends to occur during rolling. Therefore, when Mn is contained in the sacrificial material 4, in order to obtain the Mn-contained effect, the content of Mn is adjusted to 0.10% by mass or more and 2.0% by mass or less. The content of Mn is preferably 0.20% by mass or more, more preferably 0.30% by mass or more, from the viewpoint of further improving the above effect. In addition, the content is preferably 1.5% by mass or less, more preferably 1.3% by mass or less, from the viewpoint of further suppressing formation of coarse intermetallic compounds. Note that the content of Mn may be 0% by mass.

### (Ti in Sacrificial Material: 0.01% by Mass or More and 0.30% by Mass or Less)

Ti can distribute in an Al alloy in a layered manner, thereby stratifying a corrosion form and reducing the progressing rate of corrosion in a plate thickness direction. Therefore, Ti contributes to improvement of the corrosion resistance. When the content of Ti is less than 0.01% by mass, the effect of improving the corrosion resistance is insufficiently obtained. On the other hand, when the content of Ti exceeds 0.30% by mass, coarse Al₃Ti intermetallic compounds tend to be formed during casting and workability is lowered, so that cracking tends to occur during rolling. Therefore, when Ti is contained in the sacrificial material 4, in order to obtain the Ti-contained effect, the content of Ti is adjusted to 0.01% by mass or more and 0.30% by mass or less. The content of Ti is preferably 0.03% by mass or more, more preferably 0.05% by mass or more, from the viewpoint of further improving the above effect. In addition, the content is preferably 0.25% by mass or less, more preferably 0.20% by mass or less, from the viewpoint of further suppressing formation of coarse Al₃Ti intermetallic compounds. Note that the content of Ti may be 0% by mass.

### (Cr in Sacrificial Material: 0.01% by Mass or More and 0.30% by Mass or Less)

Cr forms together with Al an Al₃Cr intermetallic compound, providing dispersion strengthening, contributing to improvement of the strength after brazing. When the content of Cr is less than 0.01% by mass, the effect of improving the strength after brazing is insufficient. On the other hand, when the content of Cr exceeds 0.30% by mass, coarse Al₃Cr intermetallic compounds are formed, so that cracking tends to occur during rolling. Therefore, when Cr is contained in the sacrificial material 4, in order to obtain the Cr-contained effect, the content of Cr is adjusted to 0.01% by mass or more and 0.30% by mass or less. The content of Cr is preferably 0.03% by mass or more, more preferably 0.05% by mass or more, from the viewpoint of further improving the above effect. In addition, the content is preferably 0.25% by mass or less, more preferably 0.20% by mass or less, from the viewpoint of further suppressing formation of coarse Al₃Cr intermetallic compounds. Note that the content of Cr may be 0% by mass.

### (Zr in Sacrificial Material: 0.01% by Mass or More and 0.30% by Mass or Less)

Zr forms together with Al an Al₃Zr intermetallic compound, providing dispersion strengthening, contributing to improvement of the strength after brazing. When the content of Zr is less than 0.01% by mass, the effect of improving the strength after brazing is insufficiently obtained. On the other hand, when the content of Zr exceeds 0.30% by mass, coarse Al₃Zr intermetallic compounds are formed during casting, workability is lowered, and cracking tends to occur during rolling. Therefore, when Zr is contained in the sacrificial material 4, in order to obtain the Zr-contained effect, the content of Zr is adjusted to 0.01% by mass or more and 0.30% by mass or less. The content of Zr is preferably 0.03% by mass or more, more preferably 0.05% by mass or more, from the viewpoint of further improving the above effect. In addition, the content is preferably 0.25% by mass or less, more preferably 0.20% by mass or less, from the viewpoint of further suppressing formation of coarse Al₃Zr intermetallic compounds. Note that the content of Zr may be 0% by mass.

### (Balance in Sacrificial Material: Al and Inevitable Impurities)

In addition to the above components, the balance in the sacrificial material 4 is Al and inevitable impurities. Examples of the inevitable impurities include Fe, In, Sn, and Ni. As long as the contents are such that Fe is at 0.30% by mass or less (preferably 0.25% by mass or less), and each of In, Sn, and Ni is at 0.05% by mass or less (preferably 0.03% by mass or less), they do not prevent the effect of an embodiment of the present invention. Accordingly, they are allowed to be contained in the sacrificial material 4. Regarding the above-mentioned Si, Mn, Ti, Cr, and Zr, they can be regarded as inevitable impurities when each of them is contained below the lower limit. In addition, regarding the above-mentioned Mg, the above-mentioned predetermined amount may be contained as an inevitable impurity.

Regarding Fe, In, Sn, Ni, and the like, as long as each of them does not exceed the above-mentioned predetermined content, not only when they are contained as inevitable impurities but also when they are positively added, they do not prevent the effect of an embodiment of the present invention.

The thickness of the sacrificial material 4 is not particularly limited, but from the viewpoint of improving the corrosion resistance of the inner surface for a sacrificial anode material, the thickness is preferably 15 μm or more. In addition, the thickness is preferably 50 μm or less, from the viewpoint of improving the manufacturability of cladding.

### <Intermediate Material>

The intermediate material 5 according to an embodiment of the present invention contains a predetermined amount of Mg, with a balance being Al and inevitable impurities.

In addition, the intermediate material 5 according to an embodiment of the present invention preferably further contains a predetermined amount of Si. In addition, the intermediate material 5 according to an embodiment of the present invention preferably further contains a predetermined amount of Mn. In addition, the intermediate material 5 according to an embodiment of the present invention preferably further contains less than a predetermined amount of Zn. Furthermore, the intermediate material 5 according to an embodiment of the present invention preferably further contains a predetermined amount of at least one selected from the group consisting of Ti, Cr and, Zr.

A description will be made below of each of elements constituting the intermediate material 5 according to an embodiment of the present invention. Note that the content of each component is the content in the whole intermediate material 5.

### (Mg in Intermediate Material: 0.05% by Mass or More and 3.0% by Mass or Less)

Mg diffuses into the core material 2 at the time of brazing, contributing to improvement of the strength of the core material 2 after brazing. In addition, when the core material 2 contains Si, Mg forms together with Si a precipitated phase, providing precipitation strengthening, contributing to further improvement of the strength after brazing. When the content of Mg is less than 0.05% by mass, the effect of improving the strength after brazing is insufficient. On the other hand, when the content of Mg exceeds 3.0% by mass, it may be more difficult to clad the core material 2 with the intermediate material 5. Therefore, the content of Mg in the intermediate material is adjusted to 0.05% by mass or more and 3.0% by mass or less. The content of Mg is preferably 0.20% by mass or more, more preferably 0.40% by mass or more, from the viewpoint of further improving the above effect. In addition, the content is preferably 2.7% by mass or less, more preferably 2.5% by mass or less, from the viewpoint of further ensuring the manufacturability of cladding the core material 2 with the intermediate material 5.

### (Si in Intermediate Material: 0.20% by Mass or More and 1.0% by Mass or Less)

Si forms together with Mg a precipitated phase, providing precipitation strengthening, contributing to further improvement of the strength after brazing. When the content of Si is less than 0.20% by mass, the effect of improving the strength after brazing due to formation of the precipitated phase with Mg is insufficient. On the other hand, when the content of Si exceeds 1.0% by mass, the solidus temperature is lowered, so that the intermediate material 5 may melt at the time of brazing. Therefore, when Si is contained in the intermediate material 5, in order to obtain the Si-contained effect, the content of Si is adjusted to 0.20% by mass or more and 1.0% by mass or less. The content of Si is preferably 0.22% by mass or more, more preferably 0.25% by mass or more, from the viewpoint of further improving the above effect. In addition, the content is preferably 0.90% by mass or less, more preferably 0.80% by mass or less, from the viewpoint of further suppressing lowering of the solidus temperature. Note that the content of Si may be 0% by mass.

### (Mn in Intermediate Material: 0.10% by Mass or More and 2.0% by Mass or Less)

Mn contributes to improvement of the strength after brazing by solid solution strengthening. When the content of Mn is less than 0.10% by mass, the effect of improving the strength after brazing is insufficient. On the other hand, when the content of Mn exceeds 2.0% by mass, coarse intermetallic compounds are formed during casting and workability is lowered, so that cracking tends to occur during rolling. Therefore, when Mn is contained in the intermediate material 5, in order to obtain the Mn-contained effect, the content of Mn is adjusted to 0.10% by mass or more and 2.0% by mass or less. The content of Mn is preferably 0.20% by mass or more, more preferably 0.30% by mass or more, from the viewpoint of further improving the above effect. In addition, the content is preferably 1.65% by mass or less, more preferably 1.2% by mass or less, from the viewpoint of further suppressing formation of coarse intermetallic compounds. Note that the content of Mn may be 0% by mass.

(Zn in Intermediate Material: Less than 1.0% by Mass)

Zn improves the corrosion resistance on the side of the sacrificial material. However, when the content of Zn is 1.0% by mass or more, the corrosion resistance on the side of the brazing material is lowered. Therefore, when Zn is contained in the intermediate material 5, in order to ensure the corrosion resistance on the side of the brazing material, the content of Zn is regulated to less than 1.0% by mass. The content of Zn is preferably 0.5% by mass or less, more preferably 0.2% by mass or less, from the viewpoint of further suppressing lowering of the corrosion resistance on the side of the brazing material. Note that the lower limit is not particularly limited, and the content of Zn may be 0% by mass.

### (Ti in Intermediate Material: 0.01% by Mass or More and 0.30% by Mass or Less)

Ti can distribute in an Al alloy in a layered manner, thereby stratifying a corrosion form and reducing the progressing rate of corrosion in a plate thickness direction. Therefore, Ti contributes to improvement of the corrosion resistance. When the content of Ti is less than 0.01% by mass, the effect of improving the corrosion resistance is insufficiently obtained. On the other hand, when the content of Ti exceeds 0.30% by mass, coarse Al₃Ti intermetallic compounds tend to be formed during casting and workability is lowered, so that cracking tends to occur during rolling. Therefore, when Ti is contained in the intermediate material 5, in order to obtain the Ti-contained effect, the content of Ti is adjusted to 0.01% by mass or more and 0.30% by mass or less. The content of Ti is preferably 0.03% by mass or more, more preferably 0.05% by mass or more, from the viewpoint of further improving the above effect. In addition, the content is preferably 0.25% by mass or less, more preferably 0.20% by mass or less, from the viewpoint of further suppressing formation of coarse Al₃Ti intermetallic compounds. Note that the content of Ti may be 0% by mass.

### (Cr in Intermediate Material: 0.01% by Mass or More and 0.30% by Mass or Less)

Cr forms together with Al an Al₃Cr intermetallic compound, providing dispersion strengthening, contributing to improvement of the strength after brazing. When the content of Cr is less than 0.01% by mass, the effect of improving the strength after brazing is insufficient. On the other hand, when the content of Cr exceeds 0.30% by mass, coarse Al₃Cr intermetallic compounds are formed, so that cracking tends to occur during rolling. Therefore, when Cr is contained in the intermediate material 5, in order to obtain the Cr-contained effect, the content of Cr is adjusted to 0.01% by mass or more and 0.30% by mass or less. The content of Cr is preferably 0.03% by mass or more, more preferably 0.05% by mass or more, from the viewpoint of further improving the above effect. In addition, the content is preferably 0.25% by mass or less, more preferably 0.20% by mass or loss, from the viewpoint of further suppressing formation of coarse Al₃Cr intermetallic compounds. Note that the content of Cr may be 0% by mass.

### (Zr in Intermediate Material: 0.01% by Mass or More and 0.30% by Mass or Less)

Zr forms together with Al an Al₃Zr intermetallic compound, providing dispersion strengthening, contributing to improvement of the strength after brazing. When the content of Zr is less than 0.01% by mass, the effect of improving the strength after brazing is insufficiently obtained. On the other hand, when the content of Zr exceeds 0.30% by mass, coarse Al₃Zr intermetallic compounds are formed during casting, workability is lowered, and cracking tends to occur during rolling. Therefore, when Zr is contained in the intermediate material 5, in order to obtain the Zr-contained effect, the content of Zr is adjusted to 0.01% by mass or more and 0.30% by mass or less. The content of Zr is preferably 0.03% by mass or more, more preferably 0.05% by mass or more, from the viewpoint of further improving the above effect. In addition, the content is preferably 0.25% by mass or less, more preferably 0.20% by mass or less, from the viewpoint of further suppressing formation of coarse Al₃Zr intermetallic compounds. Note that the content of Zr may be 0% by mass.

### (Balance in Intermediate Material: Al and Inevitable Impurities)

In addition to the above components, the balance in the intermediate material 5 is Al and inevitable impurities. Examples of the inevitable impurities include Fe, In, Sn, and Ni. As long as the contents are such that Fe is at 0.30% by mass or less (preferably 0.25% by mass or loss), and each of In, Sn, and Ni is at 0.05% by mass or less (preferably 0.03% by mass or less), they do not prevent the effect of an embodiment of the present invention. Accordingly, they are allowed to be contained in the intermediate material 5. Regarding the above-mentioned Si, Mn, Ti, Cr, and Zr, they can be regarded as inevitable impurities when each of them is contained below the lower limit. In addition, regarding the above-mentioned Zn, the above-mentioned predetermined amount may be contained as an inevitable impurity.

Regarding Fe, In, Sn, Ni, and the like, as long as each of them does not exceed the above-mentioned predetermined content, not only when they are contained as inevitable impurities but also when they are positively added, they do not prevent the effect of an embodiment of the present invention.

The thickness of the intermediate material 5 is not particularly limited, but from the viewpoint of improving the strength, preferably 15 m or more. In addition, the thickness is preferably 50 μm or less, from the viewpoint of improving the manufacturability of cladding.

### <Plate Thickness of Brazing Sheet>

The plate thickness of the brazing sheet 1 is less than 200 μm. When the plate thickness of the brazing sheet 1 is less than 200 μm, it is possible to further reduce the weight of heat exchanger for automobile and the like. The plate thickness of the brazing sheet 1 is preferably 180 μm or less, more preferably 170 μm or less, from the viewpoint of reducing the weight of heat exchanger. In addition, the plate thickness is preferably 80 μm or more, more preferably 90 m or more, from the viewpoint of ensuring the strength and corrosion resistance.

### <Method for Producing Brazing Sheet>

The core material, sacrificial material, intermediate material, and brazing material which are materials for the aluminum alloy brazing sheet according to an embodiment of the present invention can be produced by a conventional method. This method for producing the core material, sacrificial material, intermediate material, and brazing material is not particularly limited. For example, they can be produced by the following methods.

An aluminum alloy for core material and an aluminum alloy for intermediate material having the above-mentioned composition are casted at a predetermined casting temperature, and each obtained ingot is subjected to face cutting, if necessary, and subjected to homogenizing heat treatment, so that an ingot for core material and an ingot for intermediate material can be produced. In addition, an aluminum alloy for sacrificial material and an aluminum alloy for brazing material having the above-mentioned composition are casted at a predetermined casting temperature, and then each obtained ingot is subjected to face cutting, if necessary, and subjected to homogenizing heat treatment. Followed by hot rolling, a member for sacrificial material and a member for brazing material can be produced.

Thereafter, the member for brazing material is overlaid on one side surface of the ingot for core material, and the ingot for intermediate material and the member for sacrificial material are overlapped on the other side surface thereof. Subsequently, they are subjected to hot rolling to form a plate material through cladding/rolling. Then, the plate material is subjected to cold rolling to produce an aluminum alloy clad material having a predetermined plate thickness as the brazing sheet. The plate material may undergo an annealing step, if necessary, during or after the cold rolling.

The aluminum alloy brazing sheet and the method for producing the same according to an embodiment of the present invention are as described above. When an embodiment of the present invention is carried out, regarding not explicitly stated conditions and the like, conventionally and publicly known ones can be applied. As long as the effect obtained under the above conditions are exhibited, other conditions and the like are not limited.

### EXAMPLES

Next, a more detailed description will be made of an embodiment of the present invention with reference to examples.

An aluminum alloy for core material, aluminum alloy for sacrificial material, aluminum alloy for intermediate material, and aluminum alloy for brazing material each having the composition shown in Tables 1 to 4 were melted, casted, and subjected to homogenizing heat treatment according to conventional methods to produce an ingot for core material (a member for core material), ingot for sacrificial material, ingot for intermediate material (a member for intermediate material), and ingot for brazing material. The ingot for sacrificial material and ingot for brazing material were each hot rolled so as to have a predetermined thickness, producing a member for sacrificial material and member for brazing material. Then, the member for brazing material was placed on one side surface of the member for core material, and the member for intermediate material and member for sacrificial material were laminated on the other side surface in various combinations shown in Tables 5 and 6, and they were cladded by hot rolling to form a plate material. Thereafter, cold rolling was performed to produce brazing sheets (test materials Nos. 1 to 70) each having a predetermined plate thickness.

In Tables 1 to 4, those not containing the components are indicated by blanks, and numerical values not satisfying the requirement of an embodiment of the present invention are underlined.

TABLE 1

| Core | | | | | | | |
|---|---|---|---|---|---|---|---|
| material | % by mass, balance: Al and inevitable impurity | | | | | | |
| No. | Cu | Mn | Si | Mg | Cr | Zr | Ti |
| S1 | 1.25 | 1.35 | | | | | |
| S2 | 2.70 | 1.35 | | | | | |
| S3 | 1.70 | 0.50 | | | | | |
| S4 | 1.70 | 2.00 | | | | | |
| S5 | 1.70 | 1.35 | 0.05 | | | | |
| S6 | 1.25 | 1.35 | 0.50 | | | | |
| S7 | 1.70 | 1.35 | | 0.05 | | | 0.05 |
| S8 | 1.70 | 1.35 | | 0.50 | 0.05 | | |
| S9 | 1.70 | 1.35 | | | 0.30 | 0.05 | |
| S10 | 1.70 | 1.35 | | | | 0.30 | |
| S11 | 1.70 | 1.35 | | | | | 0.30 |
| S12 | 1.70 | 1.35 | 0.25 | 0.20 | | | 0.15 |
| S13 | 1.70 | 1.35 | 0.25 | 0.20 | | 0.15 | |
| S14 | 1.70 | 1.35 | 0.25 | 0.20 | 0.15 | | |
| S15 | 1.20 | 1.35 | | | | | |
| S16 | 2.80 | 1.35 | | | | | |
| S17 | 1.70 | 0.45 | | | | | |
| S18 | 1.70 | 2.05 | | | | | |
| S19 | 1.70 | 1.35 | 0.55 | | | | |
| S20 | 1.70 | 1.35 | | 0.55 | | | |
| S21 | 1.70 | 1.35 | | | 0.35 | | |
| S22 | 1.70 | 1.35 | | | | 0.35 | |
| S23 | 1.70 | 1.35 | | | | | 0.35 |

TABLE 2

| Brazing | % by mass, balance: |
|---|---|
| material | Al and inevitable impurity |
| No. | Si |
| R1 | 10.0 |
| R2 | 5.0 |
| R3 | 12.5 |

TABLE 3

| Sacrificial | | | | | | | |
|---|---|---|---|---|---|---|---|
| material | % by mass, balance: Al and inevitable impurity | | | | | | |
| No. | Zn | Mg | Si | Mn | Ti | Cr | Zr |
| F1 | 2.00 | 0.03 | | | | | |
| F2 | 12.00 | 0.03 | | | | | |
| F3 | 7.00 | | | | | | |
| F4 | 4.00 | | 0.20 | | | | |
| F5 | 4.00 | | 1.00 | | | | |
| F6 | 4.00 | | | 0.10 | | | |
| F7 | 4.00 | | | 2.00 | | | |
| F8 | 4.00 | | | | 0.30 | | |
| F9 | 4.00 | | | | | 0.30 | |
| F10 | 4.00 | | | | | | 0.30 |
| F11 | 1.50 | | | | | | |
| F12 | 13.00 | | | | | | |
| F13 | 4.00 | 0.10 | | | | | |
| F14 | 4.00 | | 1.10 | | | | |
| F15 | 4.00 | | | 2.10 | | | |
| F16 | 4.00 | | | | 0.35 | | |
| F17 | 4.00 | | | | | 0.35 | |
| F18 | 4.00 | | | | | | 0.35 |

TABLE 4

| Intermediate | | | | | | | |
|---|---|---|---|---|---|---|---|
| material | % by mass, balance: Al and inevitable impurity | | | | | | |
| No. | Mg | Zn | Si | Mn | Ti | Cr | Zr |
| C1 | 1.70 | 0.90 | | | | | |
| C2 | 1.70 | 0.50 | | | | | |
| C3 | 0.15 | 0.30 | | | | | |
| C4 | 3.00 | | | | | | |
| C5 | 1.70 | | 0.20 | | | | |
| C6 | 1.70 | | 1.00 | | | | |
| C7 | 1.70 | | | 0.10 | | | |
| C8 | 1.70 | | | 2.00 | | | |
| C9 | 1.70 | | | | 0.30 | | |
| C10 | 1.70 | | | | | 0.30 | |
| C11 | 1.70 | | | | | | 0.30 |
| C12 | 1.70 | 1.10 | | | | | |
| C13 | 0.03 | | | | | | |
| C14 | 3.10 | | | | | | |
| C15 | 1.70 | | 1.10 | | | | |
| C16 | 1.70 | | | 2.10 | | | |
| C17 | 1.70 | | | | 0.35 | | |
| C18 | 1.70 | | | | | 0.35 | |
| C19 | 1.70 | | | | | | 0.35 |

The prepared brazing sheets were evaluated for the strength after brazing, brazing property, corrosion resistance on the side of the brazing material, and corrosion resistance on the side of the sacrificial material according to the following methods.

<Strength after Brazing>

Sample materials after heat treatment (heated for 3 minutes at a temperature of 590° C. or higher (maximum 600° C.) in a nitrogen atmosphere having a dew point of −40° C. and an oxygen concentration of 200 ppm or lower) according to a drop test method under a condition simulating brazing were processed into JIS No. 5 test pieces prescribed in JIS Z 2241: 2011 (3 pieces for each sample material were prepared). These test pieces were allowed to keep at room temperature (25° C.) for 1 week, then subjected to a tensile test according to the provision of JIS Z 2241: 2011 to measure the tensile strength, which was considered as the strength after brazing. Those having a mean value of strength after brazing among three test pieces of 220 MPa or more were evaluated as very good (“A”), those with 200 MPa or more as good (“B”), and those with less than 200 MPa as poor (“C”).

### <Brazing Property>

FIG. 2 is a cross-sectional view of a test piece for evaluation for evaluating the brazing property between the sides of brazing materials of an aluminum alloy brazing sheet according to an embodiment of the present invention. FIG. 3 is a cross-sectional view of a test piece for evaluation for evaluating the brazing property between the side of a brazing material and the side of a sacrificial material of an aluminum alloy brazing sheet according to an embodiment of the present invention.

Two test pieces having a surface dimension of 25 mm×20 mm were cut out of the sample material. As shown in FIG. 2, these two test pieces were each shaped such that the center in a longitudinal direction protruded, where a surface 12 on side of the brazing material was on a protrusion side. To each top of the two shaped test pieces 10 (entire protrusion side surface of the protruded portion at the center in the longitudinal direction), 10 (±0.2) g/m² of non-corrosive flux were applied. The tops were overlapped with each other as shown in FIG. 2 and brazed under a heat treatment condition simulating brazing (heated for 3 minutes at a temperature of 590° C. or higher (maximum 600° C.) in a nitrogen atmosphere having a dew point of −40° C. and an oxygen concentration of 200 ppm or lower). The test pieces after brazing were cut, and the brazing property in case where the formed fillet 14 was 3 mm or more was judged as very good (“A”), and the brazing property in case where the formed fillet 14 was less than 3 mm was judged as good (“B”). In case where the fillet 14 was not formed, the brazing property was judged as poor (“C”). Note that evaluation of brazing property was carried out only for those having good evaluation for the strength after brazing.

Similarly, two test pieces having a surface dimension of 25 mm×20 mm were cut out of the sample material. As shown in the upper portion of FIG. 3, one of the two test pieces was shaped to prepare a shaped test piece 10 such that the center in a longitudinal direction protruded, where a surface 12 on side of the brazing material was on a protrusion side. On the other hand, as shown in the lower portion of FIG. 3, the other one of the two test pieces was shaped to prepare a shaped test piece 11 such that the center in the longitudinal direction protrudes, where a surface 13 on side of the sacrificial material was on a protrusion side. To each top of the two shaped test pieces 10, 11 (protrusion side surface of the protruded portion at the center in the longitudinal direction), 10 (±0.2) g/m² of non-corrosive flux were applied. The tops were overlapped with each other as shown in FIG. 3 and brazed under a heat treatment condition simulating brazing, similarly as described above. Thereafter, in the same manner as described above with reference to FIG. 2, the brazing property was evaluated.

### <Corrosion Resistance on Side of Brazing Material>

The sample material was cut to a size of 50 mm in width×60 mm in length, and 10 (±0.2) g/m² of non-corrosive flux were applied to the surface of the brazing material. A corrugated 3003-1.5 Zn fin material having a plate thickness of 60 μm was overlapped with the flux-applied surface, and they were then subjected to a heat treatment under a condition simulating brazing (heated for 3 minutes at a temperature of 590° C. or higher (maximum 600° C.) in a nitrogen atmosphere having a dew point of −40° C. and an oxygen concentration of 200 ppm or lower). Thereafter, the surface of the sacrificial material was covered with a masking seal, the seal was further folded back to the side of the brazing material, and on the surface of the brazing material, the edge portions at a distance of 5 mm from the four sides were also covered with the seal. The test piece was subjected to a SWAAT test for 500 hours. The fin material of the sample was removed, and the depth of pitting corrosion generated in a portion where the brazing material was exposed was measured. The depth of pitting corrosion was measured according to a focus depth method using an optical microscope. Those having a residual thickness of 50% or more were evaluated as very good (“A”), those with non-penetrating corrosion evaluated as good (“B”), and those with penetrating corrosion evaluated as poor (“C”). Note that evaluation of the corrosion resistance on the side of the brazing material was carried out only for those having good evaluation for all of the strength after brazing and the brazing property.

### <Corrosion Resistance on Side of Sacrificial Material>

Sample materials after heat treatment (heated for 3 minutes at a temperature of 500° C. or higher (maximum 600° C.) in a nitrogen atmosphere having a dew point of −40° C. and an oxygen concentration of 200 ppm or lower) according to a drop test method under a condition simulating brazing were cut into a size of 50 mm in width×60 mm in length to prepare sample materials for evaluation. The entire surface of the brazing material is covered with a masking seal having a size of 60 mm in width×70 mm in length, and the seal was further folded back to the side of the sacrificial material, and on the surface of the sacrificial material, the edge portions at a distance of 5 mm from the four sides were also covered with the seal. A corrosion resistance test conducting a cycle of immersing the test pieces in a test solution containing Na⁺: 118 ppm, Cl⁻: 58 ppm, SO₄²⁻: 60 ppm, Cu²⁺: 1 ppm, Fe³⁻: 30 ppm (88° C.×8 hours), then naturally cooling them to room temperature in the immersed state, and subsequently maintaining them in the room-temperature state for 16 hours for 75 cycles was carried out. The corrosion condition of the surface of the sacrificial material was observed, and those having a residual thickness of 50% or more were evaluated as very good (“A”), those with non-penetrating corrosion evaluated as good (“B”), and those with penetrating corrosion evaluated as poor (“C”). Note that evaluation of the corrosion resistance on the side of the sacrificial material was carried out only for those having good evaluation for all of the strength after brazing and the brazing property.

The results of these tests are shown in Tables 5 and 6. Note that in Table 5 and 6, those lacking the sacrificial material or intermediate material, those not evaluable, or those not evaluated are indicated by “−”, and those which do not satisfy the requirement of an embodiment of the present invention are indicated by underlining the numerical value or the like. In evaluation of the brazing property, the results for the evaluation between the sides of the brazing materials were described in the column “brazing material-brazing material”. In addition, the results for the evaluation between the side of the brazing material and the side of the sacrificial material were described in the column “brazing material-sacrificial material”.

TABLE 5

| | | | | | | | | | | | | Brazing | | | |
|---|---|---|---|---|---|---|---|---|---|---|---|---|---|---|---|
| | | | | | | | | | | | | property | | Corrosion | |
| | Brazing | | Core | | Intermediate | | Sacrificial | | | | | Brazing | | resistance | |
| | material | | material | | material | | material | | Plate | Strength | | material - | Brazing | | Side of |
| Test | | Thick- | | Thick- | | Thick- | | Thick- | thick- | after brazing | | sacri- | material - | Side of | sacri- |
| material | | ness | | ness | | ness | | ness | ness | Evalu- | Strength/ | ficial | brazing | brazing | ficial |
| No. | No. | (μm) | No. | (μm) | No. | (μm) | No. | (μm) | (μm) | ation | MPa | material | material | material | material |
| 1 | R1 | 20 | S1 | 90 | C5 | 40 | F4 | 20 | 170 | B | 200 | A | A | A | A |
| 2 | R1 | 20 | S2 | 90 | C5 | 40 | F4 | 20 | 170 | A | 279 | A | A | A | A |
| 3 | R1 | 20 | S3 | 90 | C5 | 40 | F4 | 20 | 170 | B | 201 | A | A | A | A |
| 4 | R1 | 20 | S4 | 90 | C5 | 40 | F4 | 20 | 170 | A | 243 | A | A | B | B |
| 5 | R1 | 20 | S5 | 90 | C5 | 40 | F4 | 20 | 170 | A | 226 | A | A | A | A |
| 6 | R1 | 20 | S6 | 90 | C5 | 40 | F4 | 20 | 170 | B | 218 | A | A | A | A |
| 7 | R1 | 20 | S7 | 90 | C5 | 40 | F4 | 20 | 170 | A | 227 | A | A | A | A |
| 8 | R1 | 20 | S8 | 90 | C5 | 40 | F4 | 20 | 170 | A | 256 | B | B | A | A |
| 9 | R1 | 20 | S9 | 90 | C5 | 40 | F4 | 20 | 170 | A | 228 | A | A | A | A |
| 10 | R1 | 20 | S10 | 90 | C5 | 40 | F4 | 20 | 170 | A | 226 | A | A | A | A |
| 11 | R1 | 20 | S11 | 90 | C5 | 40 | F4 | 20 | 170 | A | 224 | A | A | A | A |
| 12 | R1 | 20 | S12 | 90 | C5 | 40 | F4 | 20 | 170 | A | 246 | A | A | A | A |
| 13 | R1 | 20 | S13 | 90 | C5 | 40 | F4 | 20 | 170 | A | 247 | A | A | A | A |
| 14 | R1 | 20 | S14 | 90 | C5 | 40 | F4 | 20 | 170 | A | 248 | A | A | A | A |
| 15 | R1 | 20 | S12 | 90 | C1 | 40 | F4 | 20 | 170 | A | 243 | A | A | B | A |
| 16 | R1 | 20 | S12 | 90 | C2 | 40 | F4 | 20 | 170 | A | 248 | A | A | A | A |
| 17 | R1 | 20 | S12 | 90 | C3 | 40 | F4 | 20 | 170 | B | 202 | A | A | A | A |
| 18 | R1 | 20 | S12 | 90 | C4 | 40 | F4 | 20 | 170 | A | 289 | A | A | A | A |
| 19 | R1 | 20 | S12 | 90 | C6 | 40 | F4 | 20 | 170 | A | 254 | A | A | A | A |
| 20 | R1 | 20 | S12 | 90 | C7 | 40 | F4 | 20 | 170 | A | 244 | A | A | A | A |
| 21 | R1 | 20 | S12 | 90 | C8 | 40 | F4 | 20 | 170 | A | 254 | A | A | A | A |
| 22 | R1 | 20 | S12 | 90 | C9 | 40 | F4 | 20 | 170 | A | 244 | A | A | A | A |
| 23 | R1 | 20 | S12 | 90 | C10 | 40 | F4 | 20 | 170 | A | 245 | A | A | A | A |
| 24 | R1 | 20 | S12 | 90 | C11 | 40 | F1 | 20 | 170 | A | 245 | A | A | A | A |
| 25 | R1 | 20 | S12 | 90 | C5 | 40 | F1 | 20 | 170 | A | 239 | A | A | B | B |
| 26 | R1 | 20 | S12 | 90 | C5 | 40 | F2 | 20 | 170 | A | 249 | A | A | B | B |
| 27 | R1 | 20 | S12 | 90 | C5 | 40 | F3 | 20 | 170 | A | 242 | A | A | A | A |
| 28 | R1 | 20 | S12 | 90 | C5 | 40 | F5 | 20 | 170 | A | 254 | A | A | A | A |
| 29 | R1 | 20 | S12 | 90 | C5 | 40 | F6 | 20 | 170 | A | 245 | A | A | A | A |
| 30 | R1 | 20 | S12 | 90 | C5 | 40 | F7 | 20 | 170 | A | 254 | A | A | A | A |
| 31 | R1 | 20 | S12 | 90 | C5 | 40 | F8 | 20 | 170 | A | 244 | A | A | A | A |
| 32 | R1 | 20 | S12 | 90 | C5 | 40 | F9 | 20 | 170 | A | 247 | A | A | A | A |
| 33 | R1 | 20 | S12 | 90 | C5 | 40 | F10 | 20 | 170 | A | 246 | A | A | A | A |
| 34 | R2 | 20 | S12 | 90 | C5 | 40 | F4 | 20 | 170 | A | 223 | A | A | A | A |
| 35 | R3 | 20 | S12 | 90 | C5 | 40 | F4 | 20 | 170 | A | 246 | A | A | A | A |
| 36 | R1 | 10 | S12 | 110 | C5 | 40 | F4 | 20 | 180 | A | 247 | B | B | A | A |
| 37 | R1 | 50 | S12 | 70 | C5 | 40 | F4 | 20 | 180 | A | 243 | A | A | A | A |
| 38 | R1 | 20 | S12 | 120 | C5 | 20 | F4 | 20 | 180 | A | 244 | A | A | B | B |
| 30 | R1 | 20 | S12 | 70 | C5 | 50 | F4 | 20 | 160 | A | 258 | A | A | A | A |
| 40 | R1 | 20 | S12 | 90 | C5 | 40 | F4 | 10 | 160 | A | 256 | A | A | B | B |
| 41 | R1 | 20 | S12 | 70 | C5 | 40 | F4 | 50 | 180 | B | 213 | A | A | A | A |
| 42 | R1 | 20 | S12 | 40 | C5 | 20 | F4 | 20 | 100 | A | 263 | A | A | A | A |
| 43 | R1 | 20 | S12 | 115 | C5 | 40 | F4 | 20 | 195 | A | 247 | A | A | A | A |

TABLE 6

| | | | | | | | | | | | | Brazing | | | |
|---|---|---|---|---|---|---|---|---|---|---|---|---|---|---|---|
| | | | | | | | | | | | | property | | Corrosion | |
| | Brazing | | Core | | Intermediate | | Sacrificial | | | | | Brazing | | resistance | |
| | material | | material | | material | | material | | Plate | Strength | | material - | Brazing | | Side of |
| Test | | Thick- | | Thick- | | Thick- | | Thick- | thick- | after brazing | | sacri- | material - | Side of | sacri- |
| material | | ness | | ness | | ness | | ness | ness | Evalu- | Strength/ | ficial | brazing | brazing | ficial |
| No. | No. | (μm) | No. | (μm) | No. | (μm) | No. | (μm) | (μm) | ation | MPa | material | material | material | material |
| 44 | R1 | 20 | S15 | 90 | C5 | 40 | F4 | 20 | 170 | C | 176 | — | — | — | — |
| 45 | R1 | 20 | S16 | 90 | C5 | 40 | F4 | 20 | 170 | — | — | — | — | — | — |
| 46 | R1 | 20 | S17 | 90 | C5 | 40 | F4 | 20 | 170 | C | 170 | — | — | — | — |
| 47 | R1 | 20 | S18 | 90 | C5 | 40 | F4 | 20 | 170 | — | — | — | — | — | — |
| 48 | R1 | 20 | S19 | 90 | C5 | 40 | F4 | 20 | 170 | — | — | — | — | — | — |
| 49 | R1 | 20 | S20 | 90 | C5 | 40 | F4 | 20 | 170 | A | 231 | C | C | — | — |
| 50 | R1 | 20 | S21 | 90 | C5 | 40 | F4 | 20 | 170 | — | — | — | — | — | — |
| 51 | R1 | 20 | S22 | 90 | C5 | 40 | F4 | 20 | 170 | — | — | — | — | — | — |
| 52 | R1 | 20 | S23 | 90 | C5 | 40 | F4 | 20 | 170 | — | — | — | — | — | — |
| 53 | R1 | 20 | S12 | 90 | C12 | 40 | F4 | 20 | 170 | B | 214 | A | A | C | B |
| 54 | R1 | 20 | S12 | 90 | C13 | 40 | F4 | 20 | 170 | C | 175 | — | — | — | — |
| 55 | R1 | 20 | S12 | 90 | C14 | 40 | F4 | 20 | 170 | — | — | — | — | — | — |
| 56 | R1 | 20 | S12 | 90 | C15 | 40 | F4 | 20 | 170 | — | — | — | — | — | — |
| 57 | R1 | 20 | S12 | 90 | C16 | 40 | F4 | 20 | 170 | — | — | — | — | — | — |
| 58 | R1 | 20 | S12 | 90 | C17 | 40 | F4 | 20 | 170 | — | — | — | — | — | — |
| 59 | R1 | 20 | S12 | 90 | C18 | 40 | F4 | 20 | 170 | — | — | — | — | — | — |
| 60 | R1 | 20 | S12 | 90 | C19 | 40 | F4 | 20 | 170 | — | — | — | — | — | — |
| 61 | R1 | 20 | S12 | 90 | C5 | 40 | F11 | 20 | 170 | B | 211 | A | A | A | C |
| 62 | R1 | 20 | S12 | 90 | C5 | 40 | F12 | 20 | 170 | A | 222 | A | A | A | C |
| 63 | R1 | 20 | S12 | 90 | C5 | 40 | F13 | 20 | 170 | B | 214 | C | A | — | — |
| 64 | R1 | 20 | S12 | 90 | C5 | 46 | F14 | 20 | 170 | — | — | — | — | — | — |
| 65 | R1 | 20 | S12 | 90 | C5 | 40 | F15 | 20 | 170 | — | — | — | — | — | — |
| 66 | R1 | 20 | S12 | 90 | C5 | 40 | F16 | 20 | 170 | — | — | — | — | — | — |
| 67 | R1 | 20 | S12 | 90 | C5 | 40 | F17 | 20 | 170 | — | — | — | — | — | — |
| 68 | R1 | 20 | S12 | 90 | C5 | 40 | F18 | 20 | 170 | — | — | — | — | — | — |
| 69 | R1 | 20 | S12 | 110 | C5 | 40 | — | 0 | 170 | A | 231 | C | A | — | — |
| 70 | R1 | 20 | S12 | 110 | — | 0 | F4 | 40 | 170 | C | 178 | — | — | — | — |

As shown in Tables 5 and 6, the brazing sheets (test materials Nos. 1 to 43) satisfying the requirement of an embodiment of the present invention, produced using the core material made of an aluminum alloy (core materials No. S1 to S14), brazing material (brazing materials No. R1 to R3), sacrificial material (sacrificial materials No. F1 to F10), and intermediate material (intermediate materials No. C 1 to C 11), and satisfying the plate thickness of less than 200 μm were excellent in strength after brazing, brazing property, and corrosion resistance.

On the other hand, the test materials No. 44 to 70 which are comparative examples do not satisfy the requirement of an embodiment of the present invention, and they exhibited the following results.

Regarding the test material No. 44, the amount of Cu in the core material was so small that the evaluation of strength after brazing was poor. Regarding the test material No. 45, the amount of Cu in the core material was so large that the core material melted at the time of brazing.

Regarding the test material No. 46, the amount of Mn in the core material was so small that the evaluation of strength after brazing was poor.

Regarding the test material No. 47, the amount of Mn in the core material was so large that cracking occurred during rolling, and a sample material could not be produced.

Regarding the test material No. 48, the amount of Si in the core material was so large that the core material melted at the time of brazing.

Regarding the test material No. 49, the amount of Mg in the core material was so large that the brazing property between the side of the brazing material and the side of the sacrificial material, and the brazing property between the sides of the brazing materials were insufficient.

Regarding the test material No. 50, the amount of Cr in the core material was so large that cracking occurred during rolling, and a sample material could not be produced.

Regarding the test material No. 51, the amount of Zr in the core material was so large that cracking occurred during rolling, and a sample material could not be produced.

Regarding the test material No. 52, the amount of Ti in the core material was so large that cracking occurred during rolling, and a sample material could not be produced.

Regarding the test material No. 53, the amount of Zn in the intermediate material was so large that the evaluation of corrosion resistance on the side of the brazing material was poor.

Regarding the test material No. 54, the amount of Mg in the intermediate material was so small that the evaluation of strength after brazing was poor.

Regarding the test material No. 55, the amount of Mg in the intermediate material was so large that cladding the core with the intermediate was impossible, and a sample material could not be produced.

Regarding the test material No. 56, the amount of Si in the intermediate material was so large that the intermediate material melted at the time of brazing.

Regarding the test material No. 57, the amount of Mn in the intermediate material was so large that cracking occurred during rolling, and a sample material could not be produced.

Regarding the test material No. 58, the amount of Ti in the intermediate material was so large that cracking occurred during rolling, and a sample material could not be produced.

Regarding the test material No. 59, the amount of Cr in the intermediate material was so large that cracking occurred during rolling, and a sample material could not be produced.

Regarding the test material No. 60, the amount of Zr in the intermediate material was so large that cracking occurred during rolling, and a sample material could not be produced.

Regarding the test material No. 61, the amount of Zn in the sacrificial material was so small that the evaluation of corrosion resistance on the side of the sacrificial material was poor.

Regarding the test material No. 62, the amount of Zn in the sacrificial material was so large that the sacrificial material was early exhausted, and the evaluation of corrosion resistance on the side of the sacrificial material was poor.

Regarding the test material No. 63, the amount of Mg in the sacrificial material was so large that the brazing property between the side of the brazing material and the side of the sacrificial material was insufficient.

Regarding the test material No. 64, the amount of Si in the sacrificial material was so large that the sacrificial material melted at the time of brazing.

Regarding the test material No. 65, the amount of Mn in the sacrificial material was so large that cracking occurred during rolling, and a sample material could not be produced.

Regarding the test material No. 66, the amount of Ti in the sacrificial material was so large that cracking occurred during rolling, and a sample material could not be produced.

Regarding the test material No. 67, the amount of Cr in the sacrificial material was so large that cracking occurred during rolling, and a sample material could not be produced.

Regarding the test material No. 68, the amount of Zr in the sacrificial material was so large that cracking occurred during rolling, and a sample material could not be produced.

Regarding the test material No. 69, the sacrificial material was not provided, so that the brazing property between the side of the brazing material and the side of the sacrificial material was insufficient. Regarding the test material No. 70, the intermediate material was not provided, so that the evaluation of strength after brazing was poor.

The disclosed content in this specification includes the following aspects.

### (Aspect 1)

An aluminum alloy brazing sheet characterized by including a core material, a brazing material made of an Al—Si based alloy provided on one surface of the core material, a sacrificial material provided on another surface of the core material, and an intermediate material provided between the core material and the sacrificial material,

the plate thickness being less than 200 μm,

the core material containing Mn: 0.50% by mass or more and 2.0% by mass or less, and Cu: more than 1.20% by mass and 2.70% by mass or less, with a balance being Al and inevitable impurities,

the sacrificial material containing Zn: 2.0% by mass or more and 12.0% by mass or less, and Mg: less than 0.05% by mass (including 0% by mass), with a balance being Al and inevitable impurities,

the intermediate material containing Mg: 0.05% by mass or more and 3.0% by mass or less, with a balance being Al and inevitable impurities.

### (Aspect 2)

The aluminum alloy brazing sheet according to Aspect 1, characterized in that the core material further contains Si: 0.05% by mass or more and 0.50% by mass or less.

### (Aspect 3)

The aluminum alloy brazing sheet according to Aspect 1 or 2, characterized in that the core material further contains Mg: 0.05% by mass or more and 0.50% by mass or less.

### (Aspect 4)

The aluminum alloy brazing sheet according to any one of Aspects 1 to 3, characterized in that the core material further contains at least one selected from the group consisting of Cr: 0.01% by mass or more and 0.30% by mass or less, Zr: 0.01% by mass or more and 0.30% by mass or less, and Ti: 0.05% by mass or more and 0.30% by mass or less.

### (Aspect 5)

The aluminum alloy brazing sheet according to any one of Aspects 1 to 4, characterized in that the sacrificial material further contains Si: 0.20% by mass or more and 1.0% by mass or less.

### (Aspect 6)

The aluminum alloy brazing sheet according to any one of Aspects 1 to 5, characterized in that the sacrificial material further contains Mn: 0.10% by mass or more and 2.0% by mass or less.

### (Aspect 7)

The aluminum alloy brazing sheet according to any one of Aspects 1 to 6, characterized in that the sacrificial material further contains at least one selected from the group consisting of Ti: 0.01% by mass or more and 0.30% by mass or less, Cr: 0.01% by mass or more and 0.30% by mass or less, and Zr: 0.01% by mass or more and 0.30% by mass or less.

### (Aspect 8)

The aluminum alloy brazing sheet according to any one of Aspects 1 to 7, characterized in that the intermediate material further contains Si: 0.20% by mass or more and 1.0% by mass or less.

### (Aspect 9)

The aluminum alloy brazing sheet according to any one of Aspects 1 to 8, characterized in that the intermediate material further contains Mn: 0.10% by mass or more and 2.0% by mass or less.

### (Aspect 10)

The aluminum alloy brazing sheet according to any one of Aspects 1 to 9, characterized in that the intermediate material further contains Zn: less than 1.0% by mass.

### (Aspect 11)

The aluminum alloy brazing sheet according to any one of Aspects 1 to 10, characterized in that the intermediate material further contains at least one selected from the group consisting of Ti: 0.01% by mass or more and 0.30% by mass or less, Cr: 0.01% by mass or more and 0.30% by mass or less, and Zr: 0.01% by mass or more and 0.30% by mass or less.

This application claims priority to Japanese Patent Application No. 2016-072159 filed on Mar. 31, 2016 that serve as a basic application. Japanese Patent Application No. 2016-072159 is hereby incorporated by reference.

### REFERENCE SIGNS LIST

1: Aluminum alloy brazing sheet (brazing sheet)
2: Core material
3: Brazing material
4: Sacrificial material
5: Intermediate material
10, 11: Shaped test piece
12: Surface on side of brazing material
13: Surface on side of sacrificial material
14: Fillet

1: An aluminum alloy brazing sheet having a plate thickness less than 200 μm and comprising:
a core material,
a brazing material comprising an Al—Si based alloy disposed on one surface of the core material,
a sacrificial material disposed on another surface of the core material, and
an intermediate material disposed between the core material and the sacrificial material,
wherein the core material comprises Mn: 0.50% by mass or more and 2.0% by mass or less, Cu: more than 1.20% by mass and 2.70% by mass or less, and Al,
wherein the sacrificial material comprises Zn: 2.0% by mass or more and 12.0% by mass or less, Mg: 0% by mass or more and less than 0.05% by mass, and Al, and
wherein the intermediate material comprises Mg: 0.05% by mass or more and 3.0% by mass or less and Al.

2: The aluminum alloy brazing sheet of claim 1, wherein the core material further comprises one or more of the following:
(a) Si: 0.05% by mass or more and 0.50% by mass or less;
(b) Mg: 0.05% by mass or more and 0.50% by mass or less; and
(c) at least one selected from the group consisting of Cr: 0.01% by mass or more and 0.30% by mass or less, Zr: 0.01% by mass or more and 0.30% by mass or less, and Ti: 0.05% by mass or more and 0.30% by mass or less.

3: The aluminum alloy brazing sheet of claim 1, wherein the sacrificial material further comprises one or more of the following:
(a) Si: 0.20% by mass or more and 1.0% by mass or less;
(b) Mn: 0.10% by mass or more and 2.0% by mass or less; and
(c) at least one selected from the group consisting of Ti: 0.01% by mass or more and 0.30% by mass or less, Cr: 0.01% by mass or more and 0.30% by mass or less, and Zr: 0.01% by mass or more and 0.30% by mass or less.

4: The aluminum alloy brazing sheet of claim 2, wherein the sacrificial material further comprises one or more of the following:
(a) Si: 0.20% by mass or more and 1.0% by mass or less;
(b) Mn: 0.10% by mass or more and 2.0% by mass or less; and
(c) at least one selected from the group consisting of Ti: 0.01% by mass or more and 0.30% by mass or less, Cr: 0.01% by mass or more and 0.30% by mass or less, and Zr: 0.01% by mass or more and 0.30% by mass or less.

5: The aluminum alloy brazing sheet of claim 1, wherein the intermediate material further comprises one or more of the following:
(a) Si: 0.20% by mass or more and 1.0% by mass or less;
(b) Mn: 0.10% by mass or more and 2.0% by mass or less;
(c) Zn: less than 1.0% by mass; and
(d) at least one selected from the group consisting of Ti: 0.01% by mass or more and 0.30% by mass or less, Cr: 0.01% by mass or more and 0.30% by mass or less, and Zr: 0.01% by mass or more and 0.30% by mass or less.

6: The aluminum alloy brazing sheet of claim 2, wherein the intermediate material further comprises one or more of the following:
(a) Si: 0.20% by mass or more and 1.0% by mass or less;
(b) Mn: 0.10% by mass or more and 2.0% by mass or less;
(c) Zn: less than 1.0% by mass; and
(d) at least one selected from the group consisting of Ti: 0.01% by mass or more and 0.30% by mass or less, Cr: 0.01% by mass or more and 0.30% by mass or less, and Zr: 0.01% by mass or more and 0.30% by mass or less.

7: The aluminum alloy brazing sheet of claim 3, wherein the intermediate material further comprises one or more of the following:
(a) Si: 0.20% by mass or more and 1.0% by mass or less;
(b) Mn: 0.10% by mass or more and 2.0% by mass or less;
(c) Zn: less than 1.0% by mass; and
(d) at least one selected from the group consisting of Ti: 0.01% by mass or more and 0.30% by mass or less, Cr: 0.01% by mass or more and 0.30% by mass or less, and Zr: 0.01% by mass or more and 0.30% by mass or less.

8: The aluminum alloy brazing sheet of claim 4, wherein the intermediate material further comprises one or more of the following:
(a) Si: 0.20% by mass or more and 1.0% by mass or less;
(b) Mn: 0.10% by mass or more and 2.0% by mass or less;
(c) Zn: less than 1.0% by mass; and
(d) at least one selected from the group consisting of Ti: 0.01% by mass or more and 0.30% by mass or less, Cr: 0.01% by mass or more and 0.30% by mass or less, and Zr: 0.01% by mass or more and 0.30% by mass or less.
